(19) United States
(12) Patent Application Publication
(10) Pub. No.: US 2011/0246795 A1
(43) Pub. Date: Oct. 6, 2011

(54) POWER SUPPLY SYTEM FOR COMPUTER

(75) Inventor: HENG-CHEN KUO, Tu-Cheng (TW)

(73) Assignee: HON HAI PRECISION INDUSTRY CO., LTD., Tu-Cheng (TW)

(21) Appl. No.: 12/817,995

(22) Filed: Jun. 17, 2010

(30) Foreign Application Priority Data
Mar. 30, 2010 (TW) 99109742

(51) Int. Cl. G06F 1/26

(52) U.S. Cl. 713/300

(57) ABSTRACT

A power supply system for a computer, includes a power supply unit, a DC/DC converter circuit, memory, and a computer boot component. The power supply unit rectifies AC voltage into a first DC voltage. The DC/DC converter circuit is provided with the first DC voltage, and converts the first DC voltage into a plurality of usable DC voltages. The memory is provided with part of the plurality of usable DC voltages directly, and stores power on data which is capable of power on the computer. The computer boot component is provided with part of the plurality of usable DC voltages directly. The computer boot component is triggered to generate a power on signal to revive the power on data from the memory to power on the computer.

### BACKGROUND

1. Technical Field

The present disclosure relates to a power supply system, more particularly to a power supply system for a computer.

2. Description of Related Art

In a personal computer (PC) system, power management is adopted to conserve energy while the PC is in use and put the PC to sleep to save energy when the PC is not in use. System power states derive from the Advanced Configuration and Power Interface (ACPI) specification. They are defined as follows:
S0/Working—The CPU is fully up and running; devices are powered up and down as needed.
S1—The CPU is stopped; RAM is refreshed; the system is running in a low power mode.
S2—The CPU has no power; RAM is refreshed; the system is in a lower power mode than S1.
S3—The CPU has no power; RAM is in slow refresh mode; the power supply is generally in a reduced power mode (for example, it cannot supply much power and is running in a lower power efficiency mode).
S4—The hardware is completely off; system memory has been saved to disk.
S5/Off—the hardware is completely off; the operating system has shut down; nothing has been saved.

Usually, when the computer is revived from S5 state to S0 state, it requires a long time. In another aspect, when the computer is revived from S3 state to S0 state, it takes a shorter time than that from the S5 state. However, the computer consumes more power when it is remained in S3 state than in S5 state.

Therefore, there is room for improvement within the art to provide a power supply system for computers, which can simultaneously save boot-up time and power.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a power supply system for a computer according an embodiment.

FIG. 2 is a detailed block view of the power supply system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

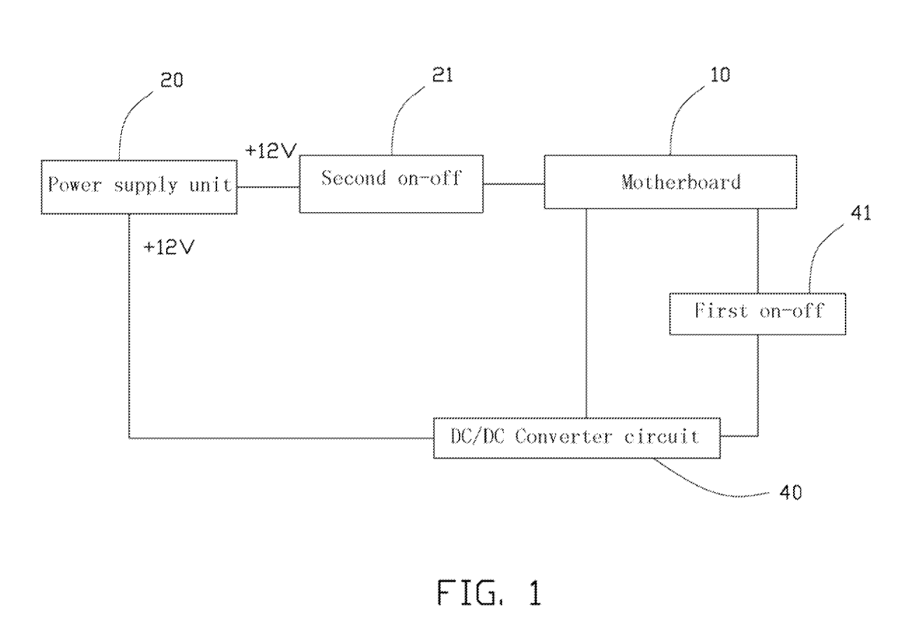

Referring to FIG. 1, a power supply system for a computer in accordance with an embodiment of the present disclosure, includes a power supply unit 20, a direct current to direct current (DC/DC) converter circuit 40, a first on-off 41, and a second on-off 21. The power supply system provides power to a motherboard 10 of the computer. The power supply unit 20 rectifies public alternating current (AC) voltage into a first DC voltage. In one embodiment, the power supply unit 20 only rectifies the AC voltage into one kind of DC voltage, such as the first DC voltage, and the first DC voltage is +12V DC voltage. Because the power supply unit 20 only rectifies one kind of DC voltage, the circuit in the power supply unit 20 is simpler than a conventional power supply, and has greater conversion efficiency.

The power supply unit 20 supplies the +12V DC voltage to the motherboard 10 via the second on-off 21. The power supply unit 20 supplies the +12V DC voltage to the DC/DC converter circuit 40 directly. The DC/DC converter circuit 40 converts the +12V DC voltage into other DC voltages that are needed by electronic components mounted on the motherboard 10 or connected to the motherboard 10. Some of the other DC voltages are supplied to the motherboard 10 directly, and some of the other DC voltages are supplied to the motherboard 10 via the first on-off 41.

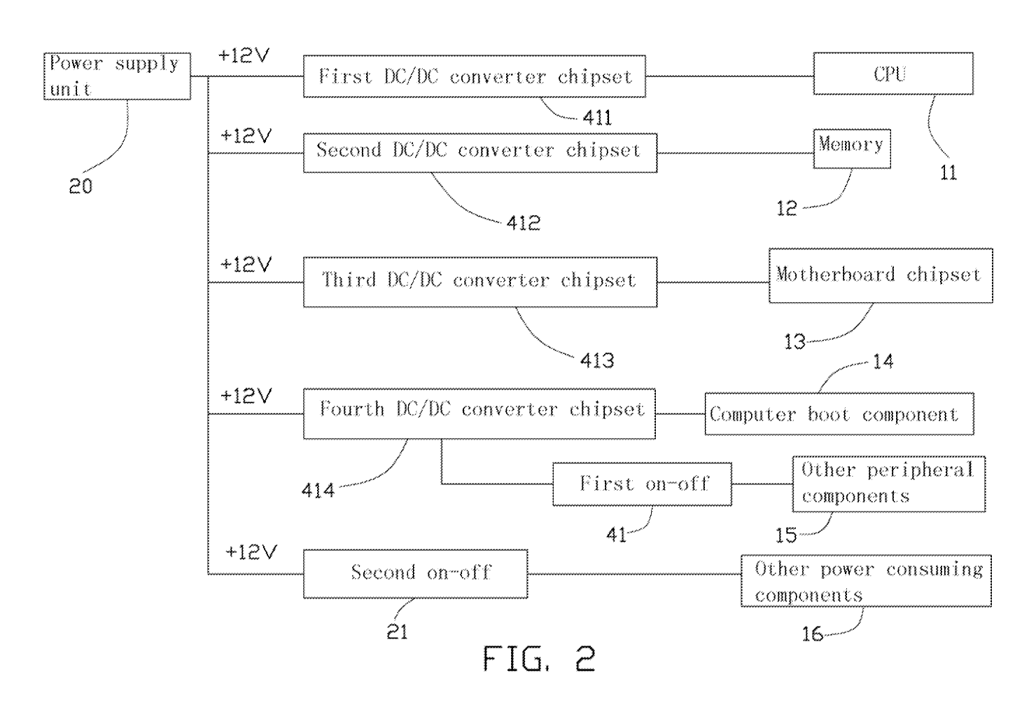

Referring to FIG. 2, a detailed block view of the power supply system of FIG. 1 is shown. The DC/DC converter circuit 40 includes a first DC/DC converter chipset 414 for CPU, a second DC/DC converter chipset 412 for memory, a third DC/DC converter chipset 413 for motherboard chipset, and a fourth DC/DC converter chipset 414 for peripheral component. The first DC/DC converter chipset 411 converts the +12V DC voltage into a second DC voltage which a CPU 11 on the motherboard 10 requires. The first DC/DC converter chipset 411 supplies the second DC voltage to the CPU 11. The second DC/DC converter chipset 412 converts the +12V DC voltage into a third DC voltage which memory 12 of the motherboard 10 requires. The second DC/DC converter chipset 412 supplies the third DC voltage to the memory 12. The third DC/DC converter chipset 413 converts the +12V DC voltage into a fourth DC voltage which motherboard chipset 13 of the motherboard 10 requires. The third DC/DC converter chipset 413 supplies the fourth DC voltage to the motherboard chipset 13. The fourth DC/DC converter chipset 414 converts the +12V DC voltage into a fifth DC voltage which peripheral components of the computer require. The peripheral components include a computer boot component 14, such as a mouse or a keyboard of the computer, and other peripheral components 15. The fourth DC/DC converter chipset 414 supplies the fifth DC voltage to the computer boot component 14 directly, and supplies the fifth DC voltage to the other peripheral components 15 via the first on-off 41. The power supply unit 20 supplies the +12V DC voltage to the other power consuming components 16 of computer via the second on-off 21.

The first DC/DC converter chipset 411, the third DC/DC converter chipset 413, the first on-off 41, and the second on-off 21 are instructed by a power on signal and a power off signal of the computer. The power on signal is capable of booting up the computer, and the power off signal is capable of shutting down the computer. When the power off signal is triggered, the first and third DC/DC converter chipsets 411 and 413 are shut down and do not provide power to the CPU 11 and the motherboard chipset 13. The first on-off 41 and the second on-off 21 are in off state. The other peripheral components 15 and the other power consuming components 16 do not consume power. Only the memory 12 and the computer boot components 14 are provided with power. Back-up data of the computer is stored in the memory 12.

When the computer boot component 14 is triggered, the power on signal is generated. The first and third DC/DC converter chipsets 411, 413 are turned on, and the first on-off 41 and the second on-off 21 are turned to on state. The power on data of the computer is revived form the memory 12, and the computer is powered on quickly.

In the above embodiment, the power supply unit 20 rectifies only one kind of DC voltage to main a high conversion efficiency of the power supply unit 20. Additionally, when the computer is shut down, the back-up data of the computer is stored in the memory. It is quick to turn on the computer to revive the back-up data from the memory 12.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A power supply system for a computer, comprising:
a power supply unit capable of converting AC voltage into a first DC voltage;
a DC/DC converter circuit connected to the power supply, and the DC/DC converter circuit capable of converting the first DC voltage into a plurality of usable DC voltages;
memory of the computer connected to the DC/DC converter circuit, and provided with part of the plurality of usable DC voltages directly from the DC/DC converter circuit, and a plurality of power on data, which is capable of powering on the computer, stored in the memory; and
a computer boot component provided with part of the plurality of usable DC voltages directly, wherein the computer boot component is capable of reviving the power on data from the memory to power on the computer.

2. The power supply system of claim 1, wherein the other of the usable DC voltages are provided to the computer via a first on-off.

3. The power supply system of claim 2, wherein the first on-off is able to turn on when the power on signal is generated and to turn off when a power off signal, which is capable of shutting down the computer, is generated.

4. The power supply system of claim 1, wherein the DC/DC converter circuit comprises a second DC/DC converter chipset and a fourth DC/DC converter chipset, the second DC/DC converter chipset is connected to the first DC voltage to convert the first DC voltage to a third DC voltage provided to the memory, the fourth DC/DC converter chipset is connected to the first DC voltage to convert the first DC voltage to a fifth DC voltage provided to the computer boot component.

5. The power supply system of claim 4, wherein the DC/DC converter circuit comprises a first DC/DC converter chipset, and the first DC/DC converter chipset is connected to the first DC voltage to convert the first DC voltage to a second DC voltage provided to a CPU.

6. The power supply system of claim 5, wherein the first DC/DC converter chipset is turned on when the power on signal is generated, and shut down when a power off signal, which is capable of shutting down the computer, is generated; and the first and fourth DC converter chipsets are always on even if the power off signal is generated.

7. The power supply system of claim 1, wherein the first DC voltage is provided to at least one power consuming component of the computer via a second on-off.

8. The power supply system of claim 7, wherein the second on-off is instructed to turn on when the power on signal is generated and to turn off when a power off signal, which is capable of shutting down the computer, is generated.

9. A computer system, comprising:
a power supply unit capable of converting AC voltage into a first DC voltage;
a first DC/DC converter chipset provided with the first DC voltage, the first DC/DC converter chipset capable of converting the first DC voltage to a second DC voltage which is provided to a first electronic component; and
a fourth DC/DC converter chipset provided with the first DC voltage, the fourth converter chipset capable of converting the first DC voltage to a fifth DC voltage which is provided to a second electronic component;
wherein the first DC/DC converter chipset is turned on when the second electronic component is triggered to generating a first control signal, and the fourth DC/DC converter chipset is always on.

10. The computer system of claim 9, wherein the second electronic component comprises a computer boot component and memory, a plurality of power on data which is capable of powering on the computer system is stored in the memory, and the computer boot component capable of reviving the power on data from the memory to power on the computer system.

11. The computer system of claim 9, wherein the fifth DC voltage is also provided to a third electronic component via a first on-off.

12. The computer system of claim 11, wherein the first on-off is instructed to turn on when the first control signal is generated and to turn off when a second control signal, which is capable of shutting down the computer system, is generated.

13. The computer system of claim 9, wherein the first DC/DC converter chipset is shut down when a second control signal, which is capable of shutting down the computer system, is generated.

14. The power supply system of claim 9, wherein the first DC voltage is provided to at least one power consuming component of the computer system via a second on-off.

15. The power supply system of claim 14, wherein the second on-off is instructed to turn on when the first control signal is generated, and to turn off when a second control signal, which is capable of shutting down the computer system, is generated.
